(19) United States
(12) Patent Application Publication
(10) Pub. No.: US 2010/0038608 A1
(43) Pub. Date: Feb. 18, 2010

(54) CLAW HAMMER WITH NAIL EJECTOR

(76) Inventor: Sergio DEGENNARO, Westbury, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/193,205

(22) Filed: Aug. 18, 2008

(51) Int. Cl. B25D 1/04

(52) U.S. Cl. 254/26 R; 254/25; 254/133 R; 81/20

(57) ABSTRACT

An improved nail ejecting apparatus in the form of a conventional claw hammer is disclosed. The improved claw hammer contains a wedge located between the two blades of the claw section of the hammer. The wedge is connected to a spring which makes contact with the in side of the hammer head. As nails are removed, the spring is compressed. After a nail is removed from a material, the force caused by the spring ejected the nails from the claw section of the hammer.

### FIELD OF THE INVENTION

The present invention relates to a claw hammer with an integral nail ejecting mechanism.

### BACKGROUND OF THE INVENTION

Claw hammers are well known in the art and form the quintessential image of a hammer to the general public. Claw hammers are defined by their crowbar structure at the rear of the head opposite the striking surface. The striking surface is used to apply force to another object, most commonly to drive a nail into a piece of wood or other building material. The claw is formed of two blades separated by a V-shaped notch. The blades of the claw are slid below the head of the nail positioning the nail head in the slot. Then the user can pull on or pivot the handle to lift the claw and raise the head of the nail from the material it is embedded in.

During the process of removing a nail, it is common for the nail to become stuck in the slot. This is especially the case when the claw is used to grip a nail, not at the head, but lower down on the shaft.

A stuck nail can be removed with finger, pliers or striking the stuck nail against another object. But all of the methods are time consuming, inconvenient and unsafe.

U.S. Pat. No. 4,200,130 to Reamy (“Reamy”) discloses a farrier's hammer for attaching and removing horse shoes. The hammer has a striking surface and a claw. Reamy also includes a spring attached between the two claw blades. This hammer is used, first to score the nail that holds a horse shoe in place, and second to break off the head using the torque created by the handle of the hammer. The spring acts to eject the removed head.

Other patents such as U.S. Pat. No. 1,318,826 to Ansley (“Ansley”) and U.S. Pat. No. 2,283,215 to Lane (“Lane”) concern nail removing devices that incorporate springs but neither spring ejects the nail from the claws.

### SUMMARY OF THE INVENTION

To solve the above mentioned problems, a claw hammer with a nail ejector is disclosed herein. The claw hammer resembles a conventional claw hammer in that it has a handle and a head including a traditional striking surface and a claw section for griping and removing nails.

Inside the head is a spring and a wedge biased by the spring into the slot formed between the blades.

As a nail is engaged by the inner surfaces of the two blades of the claw section, the wedge is moved back into the head, thereby compressing the spring. Once the nail is removed from an object, the compressed spring exerts a force on the wedge, causing it to eject the nail from the slot.

Accordingly, it is an object of the present invention to provide a nail removal apparatus that prevents nails from becoming stuck between the claw blades.

### BRIEF DESCRIPTION OF THE FIGURES

To further describe the present invention, a detailed description of typical embodiments of the invention is provided with reference to appended drawings that are not intended to limit the scope of the invention, in which:

FIG. 1 shows a front elevation view of the preferred embodiment of the inventive claw hammer constructed in accordance with the present invention;

FIG. 2 shows a top view of the preferred embodiment of the inventive claw hammer;

FIG. 3 shows a top view of the preferred embodiment of the inventive claw hammer, without the removable claw, the spring or the wedge;

FIG. 4 shows a top view of the preferred embodiment of the removable claw of the inventive claw hammer;

FIG. 5 shows a top view of the wedge of the preferred embodiment of the inventive claw hammer;

FIG. 6 shows a top view of the spring of the inventive claw hammer;

FIG. 7 shows a top view of one screw of the inventive claw hammer;

FIG. 8 shows a top view of the spring connected to the wedge of the inventive claw hammer; and

FIG. 9 is an exploded view of the preferred embodiment of the claw hammer constructed in accordance with the present invention.

### DESCRIPTION OF THE INVENTION

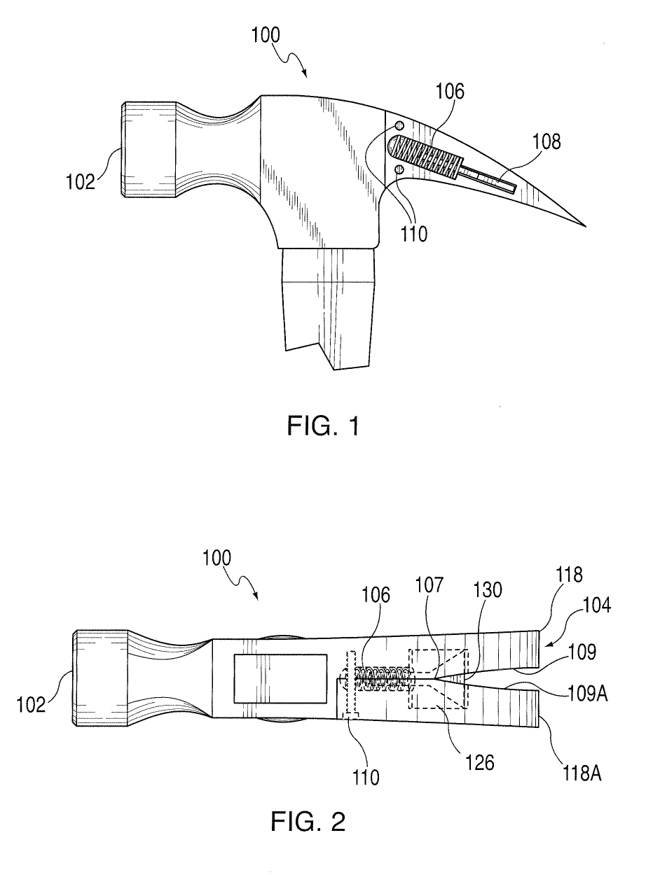

Claw hammer 100 of the present invention is shaped to resemble a conventional claw hammer. As shown in FIG. 1, claw hammer 100 has a striking surface 102, a claw section 104 and a handle 112.

As can be seen in FIG. 2, inside claw hammer 100 are a spring 106 and a wedge 108. Spring 106 is positioned in a channel 116 in the center of claw hammer 100. Channel 116 extends from the center of claw hammer 100 out through an area 107 between two claw blades 118 and 118A. Claw blades 118 and 118A each have an inner surface 109 and 109A. Spring 106 has an exterior facing side 106A and an interior facing side 106B. Attached to exterior facing side 106A of spring 106 and extending partially outside channel 116 is wedge 108. While wedge 108 extends partially beyond channel 116 at the wedge's center 120, wedge 108 is blocked at its edges 126 by claw section 104, so that it does not fall out.

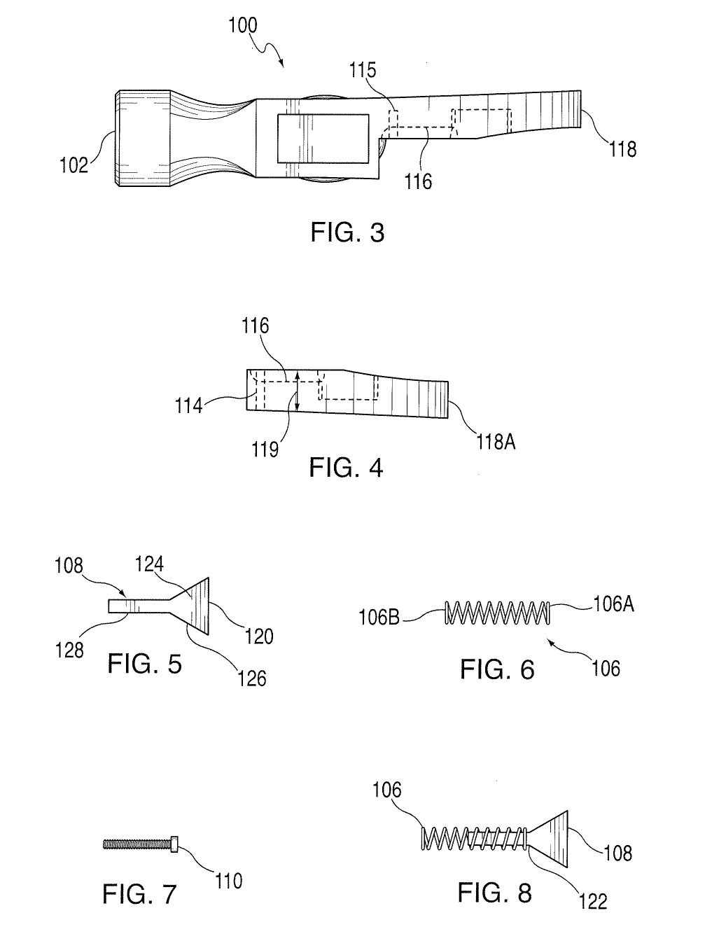

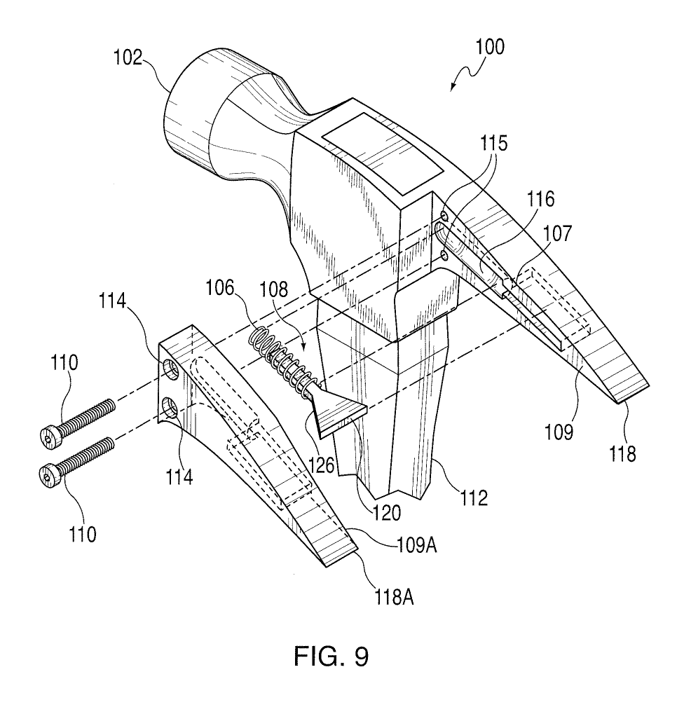

FIGS. 3-9, further show that claw blade 118A is removable. The removal of claw blade 118A allows access to channel 116, so that channel 116 can be cleaned and spring 106 can be replaced. Claw blade 118A has two fastener holes 114 and is held in place by two fasteners 110. Fasteners 110 can be of a conventional design, so they are not inconvenient to remove.

In a preferred embodiment, fasteners 110 are screws longer than the width 119 of claw blade 118, but less than twice that width. Fasteners 110 pass through fastener holes 114 of claw blade 118A and into secondary fastener holes 115. Fasteners 110 secure removable claw blade 118A in place while claw hammer 100 is being used.

Wedge 108 has a long section 128, sized to fit within channel 116, and a wide section 124 sized for making contact with a nail and for preventing wedge 108 from being removed from channel 116. Wedge 108 further has a front edge 120 which is preferably flat, but could also be inwardly or outwardly curved (only the flat embodiment is shown). Front edge 120 is flat in order to prevent the nail from getting stuck on wedge 108, as might happen if wedge 108 was V-shaped. Wedge 108 should extend from area 107 to a point 130 where the distance between inner surfaces 109 is greater than the diameter of a typical nail.

Spring 106 is preferably a metal coil spring, but can be constructed of any material and configuration that retains the physical properties of a spring, i.e., that it compresses and expands in response to force and retains potential energy when in a compressed or expanded state.

Claw hammer 100 is ideally operated as follows. Claw section 104 is used to engage a nail. Inner surfaces 109 and 109A can either be slid under the head of the nail or can grip the nail where the distance between the inner surfaces 109 and 109A becomes less than the width of the nail, i.e. point 130. If the later is the case, the inner surfaces 109 create an interference fit with the nail. As the inner surfaces 109 and 109A engage the nail, wedge 108 also engages the nail and is pressed into channel 116, thereby compressing spring 106. The further wedge 108 is pushed, the more force is exerted against the nail by spring 106.

Spring 106 will remain compressed because the user is applying a force in one direction and the nail is applying a force in the opposite direction, for as long as the nail remains lodged in a material and the user applies a force to remove it. Once the nail is dislodged, the force of spring 106 will push on wedge 108 to remove the nail.

The present invention may be embodied in other specific forms without departing from its spirit or essential characteristics. The described embodiments are to be considered in all respects only as illustrative and not as restrictive. The scope of the invention is, therefore, indicated by the appended claims and their combination in whole or in part rather than by the foregoing description. For example, described in the figures is a claw hammer with a nail remover; but the nail remover aspects of the invention can work properly without the striking surface.

What is claimed is:

1. A nail ejecting apparatus comprising:
a handle having a first end and an opposite second end;
a head connected to the first end of the handle, the head including:
a claw with a gripping element for selectively gripping an elongated member;
a wedge coupled to the claws and arranged to selectively engage the elongated member and eject it from said claw.

2. The nail ejecting apparatus of claim 1, further comprising a spring with one longitudinal end contacting the inside of the head and an opposite longitudinal end contacting the wedge and arranged to bias the wedge against said elongated member.

3. The nail ejecting apparatus of claim 1, wherein the spring is disposed within a channel.

4. The nail ejecting apparatus of claim 1, wherein the claw has a plurality of blades forming a slot for removing said elongated head.

5. The nail ejecting apparatus of claim 4, wherein the wedge is disposed in said slot.

6. The nail ejecting apparatus of claim 5, further comprising a section for capturing said wedge in said slot.

7. The nail ejecting apparatus of claim 1, wherein the wedge is disposed partially within the head and partially outside of the head.

8. The nail ejecting apparatus of claim 4, wherein one of the plurality of blades is removable from the head to allow removal of the spring and removal of the wedge.

9. A method of using a nail ejecting apparatus to remove an elongated member without the nail becoming lodged in the nail ejecting apparatus, comprising the steps of:
engaging the elongated member with a claw section of the nail ejecting apparatus such that the inner edges of two convergent members of the claw section contact and grip the elongated member;
further engaging the elongated member with a wedge such that a spring which is connected between the wedge and the nail ejecting apparatus is compressed and exerts a force in a direction away from the nail ejecting apparatus upon the elongated member;
removing the elongated member from a material such that the force causes the elongated member to release from the claw section.

10. The nail ejecting apparatus of claim 1, further comprising a striking surface connected to said head.
